(19) United States
(12) Patent Application Publication
(10) Pub. No.: US 2010/0285350 A1
(43) Pub. Date: Nov. 11, 2010

(54) ELECTROLYTIC CELL

(76) Inventor: SUENG-NIEN KAO, TAIPEI (TW)

Correspondence Address: PATENTTM.US, P. O. BOX 82788, PORTLAND, OR, 97282-0788, US

(21) Appl. No.: 12/436,244

(22) Filed: May 6, 2009

(51) Int. Cl. H01M 2/02

(52) U.S. Cl. 429/163

(57) ABSTRACT

An electrolytic cell has an insulating body, at least one metal plate, at least one carbon plate, an anode terminal connected electrically to one of at least one carbon plate and a cathode terminal connected electrically to one of at least one metal plate. The insulating body has a base and a cover. The base has two sidewalls, an opening, at least one chamber and at least one through hole. The at least one chamber is formed in the base. The at least one through hole is formed through one or all of the sidewalls. The at least one metal plate is mounted in the cover. The at least one carbon plate respectively covers the at least one through hole. Due to the carbon plate allows the air go through the carbon plate, the air can be as a depolarizer.

### BACKGROUND OF THE INVENTION

1. Field of the Invention

The present invention relates to a power supply, especially to a recyclable electrolytic cell without a depolarizer.

2. Description of the Prior Arts

Battery materials are being actively researched for improved environmental impact.

A battery may be an electrolytic cell having two electrodes, an electrolyte and a depolarizer. The depolarizer is added to the electrolyte to prevent a surface of the electrode material undergoing chemical reactions for improved battery efficiency. However, the depolarizer may be consumed so decreasing battery efficiency during use. Therefore, concentration of depolarizer should be frequently and regularly monitored and added to the electrolyte, thereby raising maintenance and running costs.

To overcome the shortcomings, the present invention provides an electrolytic cell to mitigate or obviate the aforementioned problems.

### SUMMARY OF THE INVENTION

The main objective of the present invention is to provide an electrolytic cell that is recyclable, has no depolarizer and a low environmental impact.

An electrolytic cell in accordance with the present invention has an insulating body, at least one metal plate, at least one carbon plate, an anode terminal connected electrically to the one of at least one carbon plate and a cathode terminal connected electrically to the one of at least one metal plate. The insulating body has a base and a cover. The base has two sidewalls, an opening, at least one chamber and at least one through hole. The at least one chamber is formed in the base. The at least one through hole is formed through one or all of the sidewalls. The at least one metal plate is mounted in the cover. The at least one carbon plate respectively covers the at least one through hole. Due to the carbon plate allows the air go through the carbon plate, the air can be as a depolarizer.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an electrolytic cell in accordance with the present invention;

FIG. 2 is an exploded perspective view of the first embodiment of the electrolytic cell in FIG. 1;

FIG. 3 is a side view in partial section of the first embodiment of the electrolytic cell in FIG. 1;

FIG. 4 is a top view of the first embodiment of the electrolytic cell in FIG. 1;

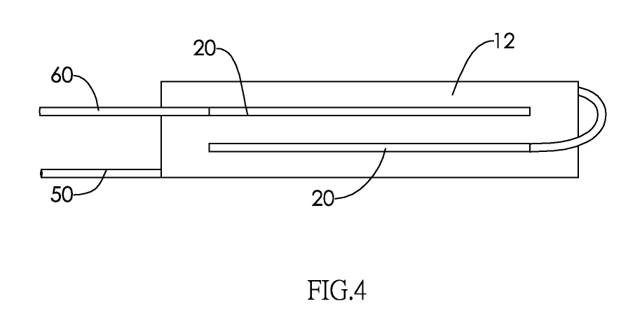

FIG. 5 is an exploded perspective view of a carbon plate of the first embodiment of the electrolytic cell in FIG. 1; and

FIG. 6 is an exploded perspective view of a second embodiment of the electrolytic cell.

### DETAILED DESCRIPTION OF THE PREFERRED EMBODIMENTS

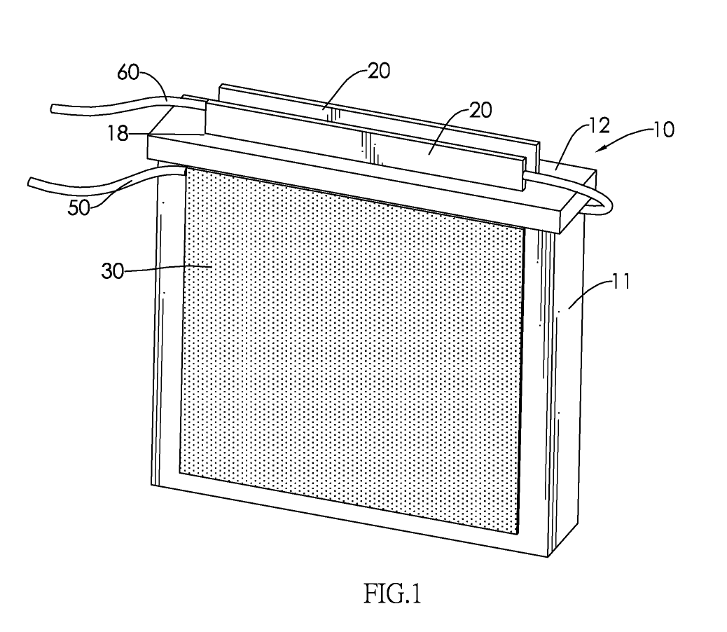

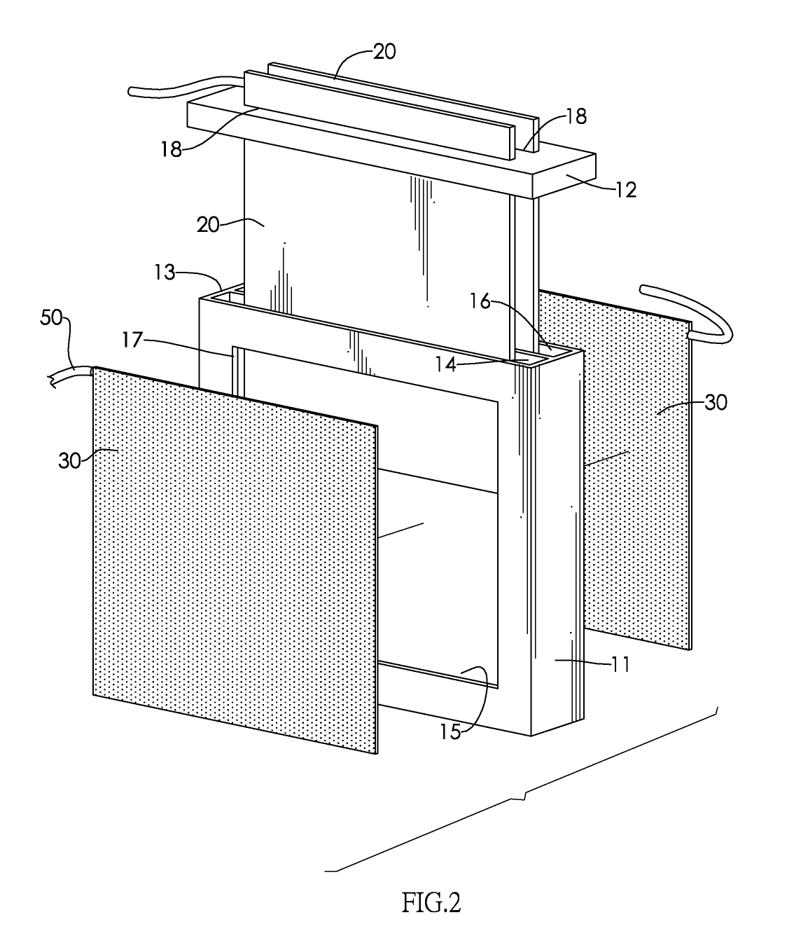

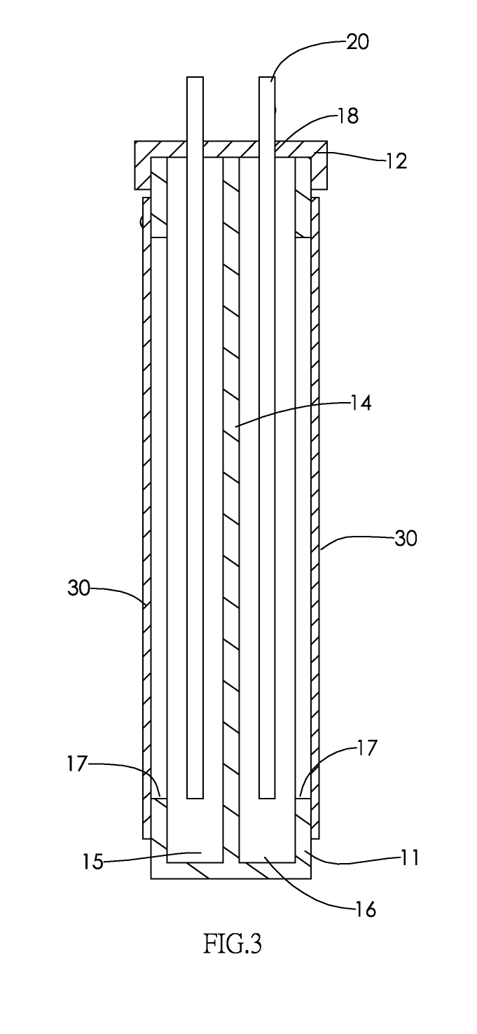

With reference to FIGS. 1 to 3, an electrolytic cell in accordance with the present invention comprises an insulating body (10), at least one metal plate (20), at least one carbon plate (30), an anode terminal (50) and a cathode terminal (60).

The insulating body (10) has a base (11) and a cover (12).

The base (11) has a top, two sidewalls, an opening (13), at least one chamber and at least one through hole (17). The opening (13) is formed on the top of the base (10). The at least one chamber is formed in the base (11) of the insulating body (10), communicates with the opening (13) of the base (11) of the insulating body (10) and has an inner surface. The least one through hole (17) communicates respectively with the at least one chamber of the base (11). Each of the at least one through hole (17) is formed through one of the sidewalls of the base (11) and.

The cover (12) covers the opening (13) of the base (11) and has a top surface and at least one inserting hole (18). The at least one inserting hole (18) is formed through the top surface of the cover (12) and respectively corresponds to the at least one chamber.

In the first embodiment, two through holes (17) and two inserting hole (18) may be implemented. The through holes (17) are respectively formed through the sidewalls. The base (11) may further have a partition (14). The partition (14) is formed on the inner surface of the chamber and divides the at least one chamber into a first chamber (15) and a second chamber (16). The first chamber (15) is adjacent to and communicates with through hole (17). The second chamber (16) is adjacent to and communicates with the other through hole (17).

The at least one metal plate (20) is at least one anode, corresponds to and is respectively mounted through the at least one inserting hole (18) of the cover (12) of the insulating body (10). In the first embodiment, two metal plate (20) may be implemented and are respectively mounted in two inserting holes (18) of the cover (12) of the insulating body (10) and may be magnesium.

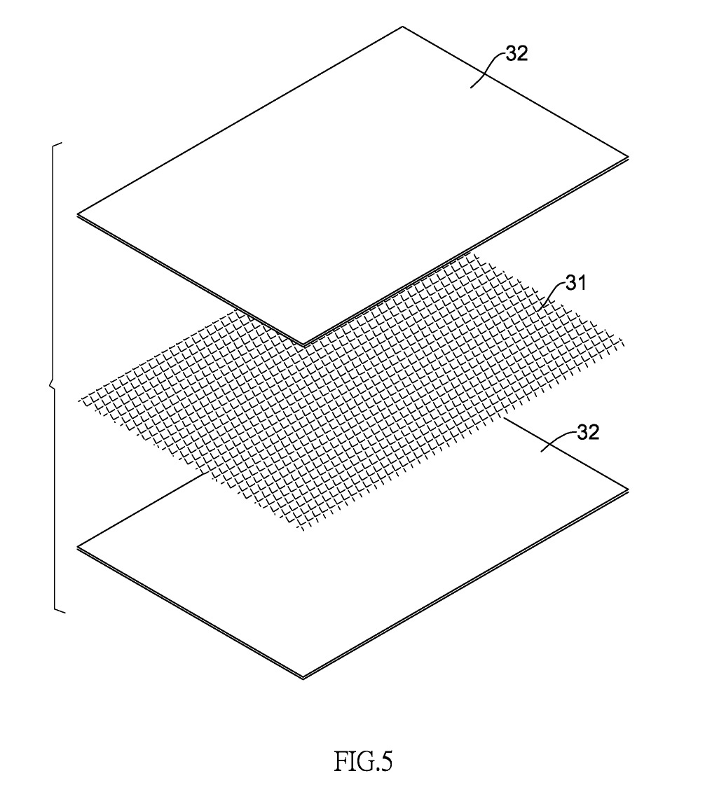

With further reference to FIG. 5, the at least one carbon plate (30) is at least one cathode. Each of the at least one carbon plate (30) is mounted on one of the sidewalls, covers one of the at least one through hole (17) of the base (11) of the insulting body (10), is located outside one of the at least one chamber and has two depolarization plates (32) and a collector grid (31).

The depolarization plates (32) may be made of carbon and polytetrafluoroethylene.

The collector grid (31) is mounted between the depolarization plates (32). In the first embodiment, two carbon plates (30) may be implemented and are respectively mounted on the sidewalls and respectively cover two through holes (17) of the base (11) of the insulting body (10). Moreover, the carbon plate (30) outside the second chamber (16) is connected electrically to the metal plate (20) mounted in the first chamber (15) through a wire.

The anode terminal (50) is connected electrically to the one of at least one carbon plate (30).

The cathode terminal (60) is connected electrically to the one of at least one metal plate (20).

In the first embodiment, the anode terminal (50) is connected electrically to the carbon plate (30) outside the first chamber (15) and the cathode terminal (60) is connected electrically to the metal plate (20) mounted in the second chamber (15).

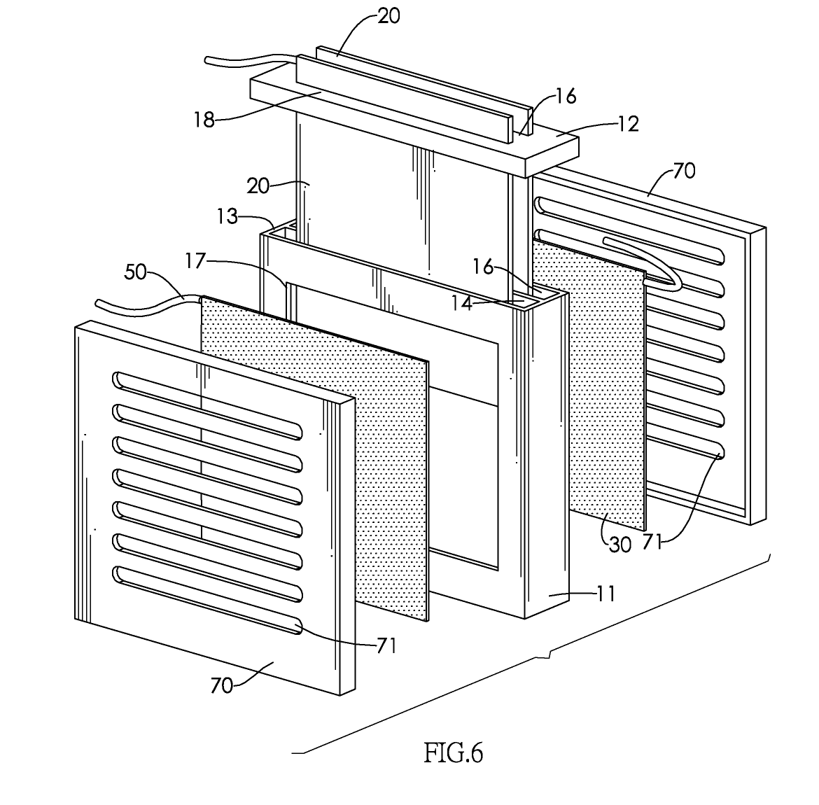

With reference to FIG. 6, the electrolytic cell of a second embodiment further has two protecting covers (70). Two protecting covers (70) are respectively mounted on two sidewalls of the insulating body and each protecting cover (70) has multiple slots (71) to allow the air pass to the protecting covers (70).

When the electrolytic cell is used, the first chamber (15) and second chamber (16) are filled with water serving as an electrolyte so that the anode (20) in the first chamber (15) and the carbon plate (30) outside the first chamber (15) are connected to form a first electrolyte cell to supply power. The anode (20) in the second chamber (16) and the carbon plate (30) outside the second chamber (16) are connected to form a second electrolyte cell to supply power. The first and second electrolyte cells are connected together in series by the wire. Due to the carbon plate (30) contacts the air and the water and allows the air pass through the depolarization plates (32), the air can be as a depolarizer for the power supply to further decrease the trouble and persecution for operator.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electrolytic cell comprising
an insulating body having
a base having
a top;
two sidewalls;
an opening being formed on the top of the base;
at least one chamber being formed in the base of the insulating body, communicating with the opening of the base of the insulating body and having an inner surface; and
at least one through hole communicating respectively with the at least one chamber of the base and each of the at least one through hole being formed through one of the sidewalls of the base; and
a cover covering the opening of the base and having
a top surface; and
at least one inserting hole being formed on the top surface of the cover and respectively corresponding to the at least one chamber;
at least one metal plate being at least one anode, respectively mounted through the at least one inserting hole of the cover of the insulating body;
at least one carbon plate being at least one cathode, each of the at least one carbon plate being mounted on one of the sidewalls, covering one of the at least one through hole of the base of the insulting body, located outside one of the at least one chamber and having
two depolarization plates; and
a collector grid being mounted between the depolarization plates;
an anode terminal connected electrically to the one of at least one carbon plate; and
a cathode terminal connected electrically to the one of at least one metal plate.

2. The electrolytic cell as claimed in claim 1,
the electrolytic cell has two through holes respectively formed through two sidewalls; and
the cover has two inserting holes; and
the base further have a partition being formed on the inner surface of the chamber and dividing the at least one chamber into a first chamber being adjacent to and communicating with through hole and a second chamber being adjacent to and communicating with the other through hole;
two metal plates are respectively mounted in the inserting holes of the cover of the insulating body;
two carbon plates are respectively mounted on the sidewalls and respectively cover the through holes of the base of the insulting body;
the anode terminal is connected electrically to the carbon plate outside the first chamber; and
the cathode terminal is connected electrically to the metal plate mounted in the second chamber; wherein
the carbon plate outside the second chamber is connected electrically to the metal plate mounted in the first chamber.

3. The electrolytic cell as claimed in claim 2, the electrolytic cell further has two protecting covers being respectively mounted on two sidewalls of the insulating body and each protecting cover has multiple slots.

4. The electrolytic cell as claimed in claim 3, each metal plate is magnesium.

5. The electrolytic cell as claimed in claim 1, wherein the depolarization plates is made of carbon and polytetrafluoroethylene.
